(19) United States
(12) Patent Application Publication
(10) Pub. No.: US 2015/0372724 A1
(43) Pub. Date: Dec. 24, 2015

(54) METHOD AND APPARATUS FOR CONFIGURING COORDINATED MULTI-POINT MEASUREMENT SET

(71) Applicant: ALCATEL LUCENT, Paris (FR)

(72) Inventors: Yun Deng, Shanghai (CN); Zhilan Xiong, Shanghai (CN); Min Zhang, Swindon (GB)

(73) Assignee: Alcatel Lucent, Boulogne Billancourt (FR)

(21) Appl. No.: 14/655,576

(22) PCT Filed: Dec. 16, 2013
(86) PCT No.: PCT/IB2013/003005

§ 371 Date: Jun. 25, 2015

(30) Foreign Application Priority Data
Dec. 27, 2012 (CN) 201210581648.3

(51) Int. Cl. H04B 7/02; H04B 17/382

(52) U.S. Cl. CPC H04B 7/024; H04B 17/382; H04W 84/042

(57) ABSTRACT

Method and an apparatus for configuring a coordinated multi-point measurement set. An embodiment of the present invention provides a method at a neighboring base station side (26) for configuring a coordinated multi-point measurement set for a user equipment UE (22), and the method includes: a neighboring base station (26) of the UE (22) receiving (40), from a serving base station (24) of the UE (22), configuration information about an uplink signal sent by the UE (22); the neighboring base station (26) detecting (42), according to the configuration information, the uplink signal sent by the UE; and the neighboring base station reporting (44), to the serving base station (24), a transmission port TP receiving the uplink signal and strength of the TP receiving the uplink signal. The present invention is based on the latest development demands of LTE/LTE-A protocols, and is applicable to various scenes.

### BACKGROUND OF THE INVENTION

1. Field of the Invention

The present invention relates to coordinated multi-point technologies, and in particular, to a method and an apparatus for configuring a coordinated multi-point measurement set.

2. Description of the Prior Art

Coordinated multi-point transmission is a promising technology in the Long Term Evolution-Advanced (LTE-Advanced) project, which can effectively reduce inter-cell interference (ICI), and improve the high data speed coverage, cell edge throughput, and/or system throughput. For example, for a user equipment (UE) supporting multi-point cooperation, when it encounters in-band interference, the network can use coordinated multi-point to reduce the interference and improve the throughput. This first requires the network to determine which transmission ports (TPs), for example, cells or Radio Resource Heads (RRHs), are suitable for being used as measurement sets of the UE, and then the UE can be configured to report corresponding channel state information (CSI), so as to facilitate it to adopt an appropriate coordinated multi-point mode, such as coordinated scheduling/beamforming (CS/CB), dynamic point selection (DPS), or joint transmission (JT).

However, the current protocols provide no clear and perfect mechanisms for how to configure a coordinated multi-point measurement set, and some general ideas have also encountered different problems, such as technical exclusion or no support for some scenes caused by protocol development. How to follow the protocol development to find another way to solve the problem of the coordinated multi-point measurement set becomes one of the problems to be urgently solved in coordinated multi-point development.

### SUMMARY OF THE INVENTION

An objective of the present invention is to provide a method and an apparatus for configuring a coordinated multi-point measurement set, which can be compatible with an existing protocol and is applicable to various scenes of LTE/LTE-A.

An embodiment of the present invention provides a method at a neighboring base station side for configuring a coordinated multi-point measurement set for a UE, and the method includes: a neighboring base station of the UE receiving, from a serving base station of the UE, configuration information about an uplink signal sent by the UE; the neighboring base station detecting, according to the configuration information, the uplink signal sent by the UE; and the neighboring base station reporting, to the serving base station, a TP receiving the uplink signal and strength of the TP receiving the uplink signal.

In an embodiment, the method further includes: the neighboring base station receiving an indication of the serving base station, and opening a TP in an off state in the TP according to the indication. At an X2 interface, the method further includes: the neighboring base station receiving, from the serving base station, a time difference therebetween. The uplink signal may be a sounding reference signal, the configuration information is cell-specific configuration information, that is, sounding reference signal uplink common configuration, and the sounding reference signal uplink common configuration includes sounding reference signal bandwidth configuration and sounding reference signal subframe configuration. In an embodiment, the configuration information further includes UE-specific configuration information, that is, sounding reference signal uplink dedicated configuration information linked to the UE, and the sounding reference signal uplink dedicated configuration information includes sounding reference signal bandwidth, sounding reference signal frequency hopping bandwidth, a frequency domain position, a sounding reference signal configuration index, transmission comb, and cyclic shift. In another embodiment, the uplink signal is a physical uplink control channel resource, the configuration information includes a channel quality indication-physical uplink control channel resource configuration index, physical uplink control channel common configuration, a pre-coding matrix index configuration index, a rank indication configuration index, and a serving cell identifier. In another embodiment, the uplink signal is a demodulation reference signal; the method further includes: the neighboring base station receiving scheduling information indicating that the serving base station schedules the UE, and demodulation reference signal configuration information of the UE.

Correspondingly, another embodiment of the present invention provides a method at a serving base station side for configuring a coordinated multi-point measurement set for a UE. The method includes: a serving base station of the UE sending, to a neighboring base station of the UE, configuration information about an uplink signal sent by the UE; and the serving base station receiving a TP receiving the uplink signal and strength of the TP receiving the uplink signal, where the TP and the strength are reported by the neighboring base station.

In an embodiment, the method further includes: the serving base station configuring a coordinated multi-point measurement set for the UE according to the report and a legacy reference signal receiving power measurement report reported by the UE. When the uplink signal is a demodulation reference signal, the method further includes: the serving base station scheduling the UE, and notifying the neighboring base station of the scheduling information and demodulation reference signal configuration information of the UE in advance.

An embodiment of the present invention further provides a neighboring base station, and the base station includes: a configuration information receiving apparatus, used for receiving, from a serving base station of the UE, configuration information about an uplink signal sent by the UE; a detection apparatus, used for detecting, according to the configuration information, the uplink signal sent by the UE; and a reporting apparatus, used for reporting, to the serving base station, a TP receiving the uplink signal and strength of the TP receiving the uplink signal.

An embodiment of the present invention further provides a serving base station, and the base station includes: a configuration information sending apparatus, used for sending, to a neighboring base station of the UE, configuration information about an uplink signal sent by the UE; and a report receiving apparatus, used for receiving a TP receiving the uplink signal and strength of the TP receiving the uplink signal, where the TP and the strength are reported by the neighboring base station.

Another embodiment of the present invention further provides a system including the UE, the serving base station, and the neighboring base station.

The present invention solves an important problem of a coordinated multi-point technology in LTE/LTE-A, that is, a problem of configuring a coordinated multi-point measurement set; which not only adapts to requirements of different scenes, but also follows protocol development, and is conductive to coordinated multi-point promotion and application.

### BRIEF DESCRIPTION OF THE DRAWINGS

FIG. 1 is an embodiment according to Scene 4 in a protocol TR36.819;

FIG. 2 is a structural block diagram of a communication system applying a method and an apparatus for configuring a coordinated multi-point measurement set according to an embodiment of the present invention;

FIG. 3 is a flow chart of a method for configuring a coordinated multi-point measurement set according to an embodiment of the present invention; and

FIG. 4 is a flow chart of a method for configuring a coordinated multi-point measurement set according to an embodiment of the present invention.

### DETAILED DESCRIPTION

For better comprehension of the spirit of the present invention, a further description is provided in the following with reference to some exemplary embodiments of the present invention.

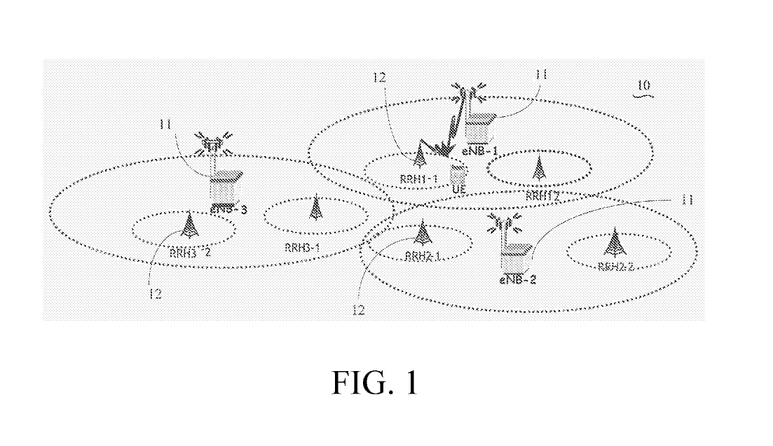

In the initial stage of coordinated multi-point development, it is conceived that the network uses a measurement report of a UE, for example, a reference signal receiving power/reference signal receiving quality (RSRP/RSRQ) of a cell-specific reference signal (CRS) and an RSRP measurement report of a channel state information-reference signal (CSI-RS) to determine a measurement set of the UE. With further development of the 3rd Generation Partnership Project (3GPP), the concept of CSI-RS RSRP is no longer introduced. Therefore, the network only can use a CRS RSRP/RSRQ measurement report to determine a measurement set of the UE. The problem lies in that such a technical solution cannot be applied to Scene 4 in a protocol TR36.819, that is, the network contains low-power RRHs in macrocell coverage, and a TP created by an RRH 11 and a macrocell have the same cell identifier. FIG. 1 is an embodiment according to Scene 4 of a protocol TR36.819. A network 10 includes three base stations 11, that is, eNB-1, eNB-2, and eNB-3; each base station 11 governs two RRHs 12, for example, eNB-1 governs RRH1-1 and RRH1-2, eNB-2 governs RRH2-1 and RRH2-2, and eNB-3 governs RRH3-1 and RRH3-2. However, some RRHs 12, for example, RRH2-1 and RRH3-1, do not transmit a CRS, and the UE cannot measure a reference signal therefrom. The corresponding network 10 cannot determine which RRHs 12 can be configured into a coordinated multi-point measurement set to the UE. It seems that some general ideas about the coordinated multi-point measurement set have been rejected, and how to be compatible with the existing protocol to configure a coordinated multi-point measurement set becomes a difficulty in coordinated multi-point development.

The method and the apparatus for configuring a coordinated multi-point measurement set according to the embodiments of the present invention well solve such a difficulty. A neighboring TP is determined by detecting an uplink signal sent by the UE, thereby selecting whether to configure the neighboring TP in the coordinated multi-point measurement set.

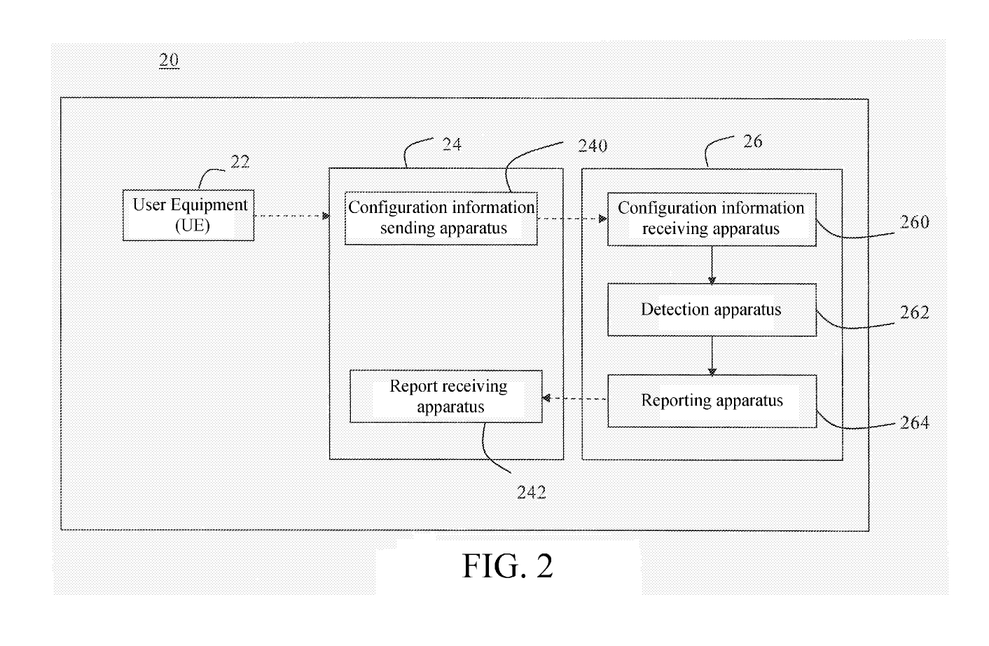

FIG. 2 is a structural block diagram of a communication system applying a method and an apparatus for configuring a coordinated multi-point measurement set according to an embodiment of the present invention. As shown in FIG. 2, the communication system 20 includes a UE 22, a serving base station (serving eNB) 24 of the UE 22, and a neighboring base station (neighboring eNB) 26 (which may be one or more, but only one is shown for clarity) of the UE 22. The serving base station 24 and the neighboring base station 26 may govern one or more TPs; the serving base station 24 is a base station governing a cell where the UE 22 is located, and the neighboring base station 26 is a base station governing a cell adjacent to the cell where the UE 22 is located. The serving base station 24 includes: a configuration information sending apparatus 240, used for sending, to the neighboring base station 26, configuration information about an uplink signal sent by the UE 22; and a report receiving apparatus 242, used for receiving a TP receiving the uplink signal and strength of the TP receiving the uplink signal, where the TP and the strength are reported by the neighboring base station 26. The neighboring base station 26 includes: a configuration information receiving apparatus 260, used for receiving, from the configuration information sending apparatus 240 of the serving base station 24, the configuration information about the uplink signal sent by the UE 22; a detection apparatus 262, used for detecting, according to the configuration information, the uplink signal sent by the UE 22; and a reporting apparatus 264, used for reporting, to the serving base station 24, the TP receiving the uplink signal and the strength of the TP receiving the uplink signal.

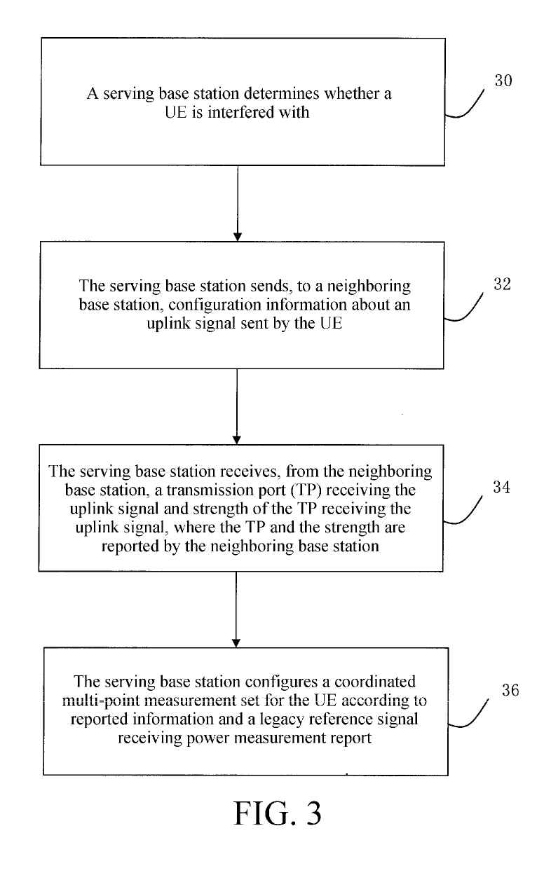

FIG. 3 is a flow chart of a method for configuring a coordinated multi-point measurement set according to an embodiment of the present invention. The method is applied to a serving base station 24 of a UE 22. Specifically, in step 30, for the UE 22 supporting multi-point cooperation, the serving base station 24 thereof may receive a legacy RSRP measurement report sent by the UE 22, and therefore determine whether the UE 22 is interfered with; or the serving base station 24 roughly determines that the UE may be in an interference region according to network topology and the legacy RSRP measurement report reported by the UE 22. It should be noted herein that, the neighboring base station 26, for saving power, may enable TPs it governs not to send a signal, where the TPs are in an off state, but at this time, the TPs may also receive a signal sent by the UE 22. If the serving base station 24 determines that the UE 22 is suffering from interference or in an interference region, the serving base station plans to adopt multi-point cooperation for the UE. Then in step 32, the configuration information sending apparatus 240 of the serving base station 24 may send, to the neighboring base station 26 of the UE 22, configuration information about an uplink signal sent by the UE 22. In step 34, the report receiving apparatus 242 of the serving base station 24 receives, from the neighboring base station 26, a TP receiving the uplink signal and strength of the TP receiving the uplink signal, where the TP and the strength are reported by the neighboring base station. In step 36, the serving base station 24 configures a coordinated multi-point measurement set for the UE 22 according to reported information and a legacy reference signal receiving power measurement report (that is, an RSRP/RSRQ measurement report about a CRS reported by the UE). For example, the serving base station 24 may select to configure a TP with the highest strength receiving the uplink signal into the measurement set of the UE 22. If the selected TP belongs to the neighboring base station 26 and the TP is in a non-open state, the serving base station 24 sends, to the neighboring base station 26, an indication of opening the TP.

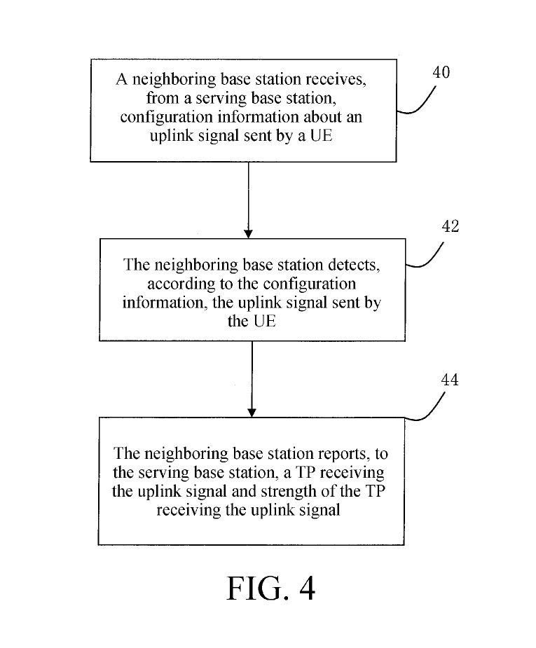

FIG. 4 is a flow chart of a method for configuring a coordinated multi-point measurement set according to an embodiment of the present invention. The method is applied to a neighboring base station 26 of a UE 22. Specifically, in step 40, a configuration information receiving apparatus 260 of a neighboring base station 26 receives, from a serving base station 24 of the UE 22, configuration information about an uplink signal sent by the UE 22. In step 42, the neighboring base station 26, for example, its detection apparatus 262, detects, according to the configuration information, the uplink signal sent by the UE 22. For example, the neighboring base station 26 may detect which TPs it governs have received the uplink signal, and how the receiving strength is. In step 44, the neighboring base station 26, for example, a reporting apparatus 264, reports, to the serving base station 24, a TP receiving the uplink signal and strength of the TP receiving the uplink signal. In an embodiment, the method further includes: the neighboring base station 26 storing the TP and the strength of the TP receiving the uplink signal, for example, storage is performed before reporting.

Uplink signals conforming to the requirements all can be applied to the present invention. For example, in an embodiment, the uplink signal is a sounding reference signal (SRS). At this time, configuration information of the uplink signal sent by the serving base station 24 is Cell-specific configuration information, that is, SRS uplink common configuration (soundingRS-UL-ConfigCommon). The SRS uplink common configuration includes SRS bandwidth configuration (srs-BandwldthConfig) and SRS subframe configuration (srs-SubframeConfig). The configuration information further includes UE-specific configuration information, that is, SRS uplink dedicated configuration information (SoundingRs-UL-ConfigDedicated) linked to the UE. The SRS uplink dedicated configuration information includes SRS-bandwidth (srs-Bandwidth), SRS frequency hopping bandwidth (srs-HoppingBandwidth), a frequency domain position (freqDomainPosition), an SRS configuration index (srs-ConfigIndex), transmission comb (transmissionComb), and cyclic shift (cyclicShift).

In an embodiment, the uplink signal is a physical uplink control channel (PUCCH) resource. At this time, the serving base station 24 notifies that configuration information of the neighboring base station 26 includes a channel quality indication-PUCCH resource index (CQI-PUCCH-ResourceIndex), PUCCH common configuration (PUCCH-ConfigCommon), a precoding matrix index configuration index (PMI-ConfigIndex) (optional), a rank indication configuration index (RI-ConfigIndex) (optional), and a serving cell identifier (Serving Cell ID).

In another embodiment, the adopted uplink signal may be a demodulation reference signal (DMRS). Generally, when the UE 22 receives an uplink license, it will send data on a designated physical uplink shared channel (PUSCH), and the DMRS is embedded in the data. In a case where the serving base station 24 dynamically schedules the PUSCH, to avoid that the neighboring base station 26 detects the DMRS in all uplink frames and the whole uplink bandwidth, preferably, the serving base station 24 schedules the UE 22 (or called pre-schedules the UE) periodically in some subframes, and notifies the neighboring base station 26 of the scheduling information and DMRS configuration information of the UE 22 in advance, so that the neighboring base station 26 can conveniently detect a DMRS of the UE 22 according to the received information.

The above embodiments all set that the serving base station 24 and the neighboring base station 26 are synchronous, while when they are not synchronous, for example, at an X2 interface, the serving base station 24 further needs to notify the neighboring base station 26 of a time difference therebetween (between two base stations), and the neighboring base station 26 may perform detection at a right time after receiving the time difference.

It should be noted that with the development of the technology and update of the standard, components having the same function generally have different names. The technical terms in the specification of the present invention patent application are used to explain and demonstrate the technical solution of the present invention, and shall be subject to common functions in the technical field rather than being randomly understood merely according to the names thereof.

The technical content and technical features of the present invention are disclosed above, and a person skilled in the art may still make various replacements and modifications without departing from the spirit of the present invention on the basis of the teaching and disclosure of the present invention. Therefore, the protection scope of the present invention shall not be limited to the content disclosed by the embodiments, but shall cover all replacements and modifications not departing from the present invention, and shall be subject to the claims of the present patent application.

1. A method for configuring a coordinated multi-point measurement set for a user equipment (UE), comprising:
a neighboring base station of the UE receiving, from a serving base station of the UE, configuration information about an uplink signal sent by the UE;
the neighboring base station detecting, according to the configuration information, the uplink signal sent by the UE; and
the neighboring base station reporting, to the serving base station, TPs (Transmission Ports) receiving the uplink signal and strength of the TPs receiving the uplink signal.

2. The method according to claim 1, further comprising:
the neighboring base station receiving an indication from the serving base station, and switching on a TP in an off state in the TPs according to the indication.

3. The method according to claim 1, wherein the uplink signal is a detection reference signal, the configuration information is cell-specific configuration information, that is, detection reference signal uplink common configuration, and the detection reference signal uplink common configuration comprises detection reference signal bandwidth configuration and detection reference signal subframe configuration.

4. (canceled)

5. The method according to claim 1, wherein, at an X2 interface, the method further comprises: the neighboring base station receiving, from the serving base station, a time difference therebetween.

6. The method according to claim 1, wherein the uplink signal is a PUCCH (Physical Uplink Control Channel) resource, the configuration information comprises a CQI (Channel Quality Indication resource configuration index, PUCCH common configuration, a PMI (Pre-coding Matrix Index) configuration index, a RI (Rank Indication) configuration index, and a serving cell identifier.

7. The method according to claim 1, wherein the uplink signal is a demodulation reference signal; the method further comprises: the neighboring base station receiving scheduling information for that the serving base station schedules the UE, and demodulation reference signal configuration information of the UE.

8. A method for configuring a coordinated multi-point measurement set for a user equipment (UE), comprising:
a serving base station of the UE sending, to a neighboring base station of the UE, configuration information about an uplink signal sent by the UE; and
the serving base station receiving a report reported by the neighboring base station about TPs (Transmission Ports) receiving the uplink signal and strength of the TP receiving the uplink signal.

9. The method according to claim 8, further comprising: the serving base station configuring a coordinated multi-point measurement set for the UE according to the report and a legacy reference signal receiving power measurement report reported by the UE.

10. (canceled)

11. (canceled)

12. The method according to claim 8, wherein, at an X2 interface, the neighboring base station receives, from the serving base station, a time difference therebetween.

13. (canceled)

14. (canceled)

15. A base station, wherein the base station is a neighboring base station of a user equipment (UE); the base station comprising:
a configuration information receiving apparatus, used for receiving, from a serving base station of the UE, configuration information about an uplink signal sent by the UE;
a detection apparatus, for detecting, according to the configuration information, the uplink signal sent by the UE; and
a reporting apparatus, for reporting, to the serving base station, TPs (Transmission Ports) receiving the uplink signal and strength of the TP receiving the uplink signal.

16. The base station according to claim 15, further comprising: receiving an indication from the serving base station, and switching on a TP in an off state in the TPs according to the indication.

17. (canceled)

18. (canceled)

19. The base station according to claim 15, wherein, at an X2 interface, the base station further receives, from the serving base station, a time difference therebetween.

20. (canceled)

21. (canceled)

22. A base station, wherein the base station is a neighboring base station of a user equipment (UE); the base station comprising:
a configuration information sending apparatus, used for sending, to a neighboring base station of the UE, configuration information about an uplink signal sent by the UE; and
a report receiving apparatus, used for receiving a report reported by the neighboring base station TPs (Transmission Ports) receiving the uplink signal and strength of the TPs receiving the uplink signal.

23. The base station according to claim 22, wherein the base station further configures a coordinated multi-point measurement set for the UE according to the TPs and the strength of the TPs receiving the uplink signal as well as a legacy reference signal receiving power measurement report reported by the UE.

24. (canceled)

25. (canceled)

26. The base station according to claim 22, wherein, at an X2 interface, the base station further sends, to the neighboring base station, a time difference therebetween.

27.-29. (canceled)
